(19) United States
(12) Patent Application Publication
(10) Pub. No.: US 2016/0046320 A1
(43) Pub. Date: Feb. 18, 2016

(54) STEERING DEVICE

(71) Applicants: JTEKT CORPORATION, Osaka (JP); HONDA MOTOR CO., LTD., Tokyo (JP)

(72) Inventor: Toshihiro TAKAHASHI, Nishio-shi (JP)

(21) Appl. No.: 14/825,467

(22) Filed: Aug. 13, 2015

(30) Foreign Application Priority Data
Aug. 18, 2014 (JP) 2014-166001

(51) Int. Cl. B62D 5/04

(52) U.S. Cl. CPC B62D 5/0463; B62D 5/0409

(57) ABSTRACT

A steering device includes: a steering mechanism which includes a steering shaft coupled with a steering wheel and a steered shaft coupled with steered wheels; a steering actuator which applies an assist torque to the steered shaft; a torque sensor which detects a steering torque applied to the steering shaft; and a control unit which controls the steering actuator so as to generate the assist torque based on the steering torque detected by the torque sensor. The steering shaft includes a column shaft which is dividable from another constituent element of the steering shaft. The steering actuator and the control unit are provided as a single unit. The torque sensor is provided at the column shaft. The torque sensor mounts therein a memory unit for storing unique information of the torque sensor.

### BACKGROUND

The present invention relates to steering devices.

As a steering device including a steering mechanism which transmits rotation of a steering shaft according to an operation of a steering wheel to a rack shaft to thereby change a direction of steered wheels, there has been provided one which assists a steering operation performed by a driver (steering assist). In order to perform the steering assist, an actuator such as a motor is used in a manner that the motor etc. are controlled according to the steering operation of a driver.

As the steering device for performing such the steering assist, a steering device described in, for example, a patent literature 1 has been proposed. The steering device according to the patent literature 1 is a rack-type electric power steering device for performing the steering assist with respect to a rack shaft, in which the rack shaft is provided with a steering power assistant unit that applies an assist force for performing the steering assist.

In the steering device described in the patent literature 1, a torque sensor for detecting a steering torque applied to a steering shaft is provided at a column shaft in the vicinity of a steering wheel. That is, in the steering device described in the patent literature 1, the torque sensor is provided independently from the steering power assistant unit.

[Patent Literature 1] JP-A-64-32966

### SUMMARY

It is therefore one advantageous aspect of the present invention to provide a steering device which can reflect suitable unique information on a detection result of a torque sensor.

According to one advantage of the invention, there is provided a steering device, comprising:

a steering mechanism which includes a steering shaft coupled with a steering wheel and a steered shaft coupled with steered wheels;

a steering actuator which applies an assist torque to the steered shaft;

a torque sensor which detects a steering torque applied to the steering shaft; and

a control unit which controls the steering actuator so as to generate the assist torque based on the steering torque detected by the torque sensor, wherein

the steering shaft includes a column shaft which is dividable from another constituent element of the steering shaft,

the steering actuator and the control unit are provided as a single unit,

the torque sensor is provided at the column shaft, and

the torque sensor mounts therein a memory unit for storing unique information of the torque sensor.

The steering device may be configured such that: the torque sensor includes a detection unit which detects the steering torque and outputs the detected steering torque as an analog signal, and a conversion unit which converts the analog signal into a digital signal and outputs the digital signal to the control unit; the memory unit is mounted in the conversion unit; and the unique information stored in the memory unit is reflected when the conversion unit converts the analog signal to the digital signal.

The steering device may be configured such that: the torque sensor includes a detection unit which detects the steering torque and outputs the detected steering torque as an analog signal to the control unit; the memory unit is mounted separately from the detection unit; and the unique information stored in the memory unit is reflected on the analog signal output from the detection unit.

The unique information may contain an offset value for offsetting the steering torque detected in the torque sensor.

### BRIEF DESCRIPTION OF DRAWINGS

FIG. 1 is a schematic diagram showing a steering device.

FIG. 2 is a diagram showing a torque sensor in a first embodiment.

FIG. 3 is a diagram for explaining a mode of replacing a unit in the steering device.

FIG. 4 is a diagram showing a torque sensor in a second embodiment.

### DETAILED DESCRIPTION OF EXEMPLIFIED EMBODIMENTS

For example, a torque sensor is required to be subjected to an offset correction with respect to a detection result thereof (in particular, a detection deviation of a neutral position of a steering wheel). An offset value for the correction is usually stored, as unique information of the torque sensor, in a control unit for controlling a steering power assistant unit. In a case where the control unit is required to be replaced due to an abnormality of a steering device, after the replacement of the control unit, if the offset value according to the torque sensor provided at the steering device is set again to the control unit having been replaced, normal control can be attained. On the other hand, in the steering device as described in the patent literature 1, in a case where the torque sensor is required to be replaced due to an abnormality of the steering device, usually it is required to replace a column assembly including a column shaft as a single unit. However, there has not been provided any means for the control unit to grasp the replacement of the column assembly. Thus, if the column assembly is replaced due to an abnormality of the steering device, an improper offset value according to the torque sensor before the replacement may be reflected on a detection result of a torque sensor having been replaced. Incidentally, various information other than an offset value may be contained as unique information of a torque sensor.

The invention, having been contrived bearing in mind the heretofore described circumstances, has for its object to provide a steering device which can reflect suitable unique information on a detection result of a torque sensor.

Hereinafter, the first embodiment of a steering device will be explained.

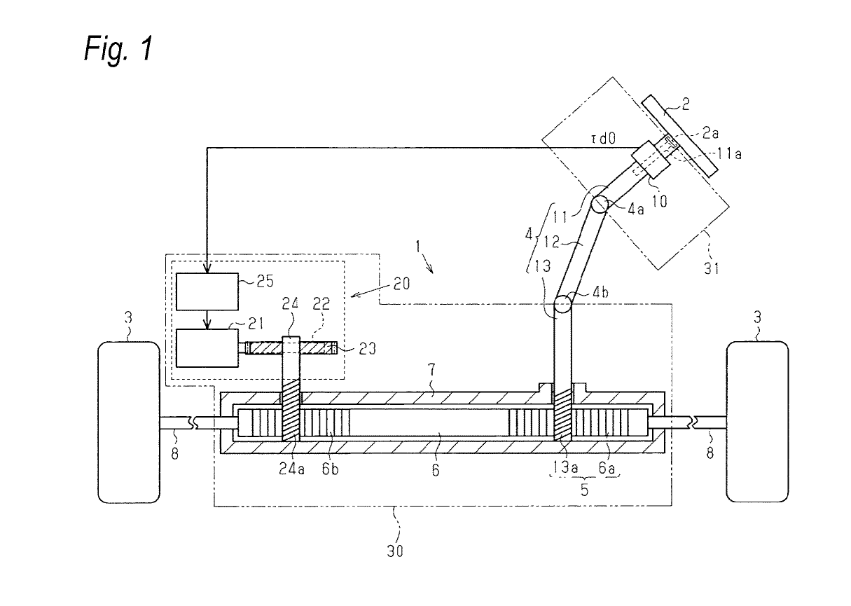

As shown in FIG. 1, the steering device according to the embodiment includes a steering mechanism 1 capable of changing a steering angle of steered wheels 3 according to an operation of a steering wheel 2 by a driver (hereinafter called “steering operation”). The steering mechanism 1 includes a steering shaft 4 acting as a rotation shaft of the steering wheel 2 and a rack shaft 6 which acts as a steered shaft coupled to the lower end portion of the steering shaft via a rack and pinion mechanism 5.

To be concrete, the steering wheel 2 is coupled (fixed) to the steering shaft 4 via a machine mechanism 2a so as to be rotatable in the circumferential direction of the steering shaft. The steering shaft 4 is constituted of, sequentially from the steering wheel 2 side, a column shaft 11 which one end is coupled to the steering wheel 2 via the machine mechanism 2a, an intermediate shaft 12 which is mechanically coupled to the column shaft 11 via a universal joint 4a, and a pinion shaft 13 which is mechanically coupled to the intermediate shaft 12 via a universal joint 4b.

The rack and pinion mechanism 5 is provided with a rack housing 7 of an almost cylindrical shape into which the rack shaft 6 is inserted so as to be movable reciprocally. The pinion shaft 13 is rotatably housed within the rack housing 7 in a manner of obliquely intersecting with the rack shaft 6. Rack teeth 6a of the rack shaft 6 engage with pinion teeth 13a of the pinion shaft 13.

In this manner, the rotation of the steering shaft 4 according to the steering operation by a driver is converted into a reciprocal linear movement of the rack shaft 6 by means of the rack and pinion mechanism 5. The steering angle of each of the steered wheels 3 is changed according to the reciprocal linear movement of the rack shaft 6.

The rack shaft 6 of the steering device is provided with a motor control unit (hereinafter called “MCU”) 20 acting as a steering force assist unit which applies an assist force for assisting the steering operation (hereinafter called “steering assist”) with respect to, in particular, the rack shaft 6 of the steering mechanism 1.

The MCU 20 includes a steering motor 21 and an ECU 25. The steering motor acts as a steering actuator which serves as a power source at the time of performing the steering assist. The ECU acts as a control unit for controlling an operation of the steering motor 21. For example, a three-phase brush motor is employed as the steering motor 21. A worm shaft 22 is coupled to an output shaft of the steering motor 21. The worm shaft 22 is coupled to a pinion shaft 24 via a worm wheel 23. The pinion shaft 24 is rotatably housed within the rack housing 7 in a manner of obliquely intersecting with the rack shaft 6. The rack teeth 6a of the rack shaft 6 engage with pinion teeth 24a of the pinion shaft 24. The MCU 20 and the rack and pinion mechanism 5 constitute a gear assembly 30 formed as a single unit.

Thus, the rotation of the steering motor 21 is transmitted to the rack shaft 6 via the worm shaft 22, the worm wheel 23 and the pinion shaft 24 to thereby perform the steering assist using the motor torque as a power. In other word, the MCU 20 of the steering device according to the embodiment can act for an electric power steering device of a rack type and also a dual pinion type.

The torque sensor 10 is connected to the ECU 25. The torque sensor 10 detects a steering torque applied to the steering wheel 2, that is, a steering torque applied to the steering mechanism 1. The torque sensor 10 is provided in the vicinity of a torsion bar 11a inserted into the column shaft 11 which is provided on the steering wheel 2 side among the respective constituent elements of the steering shaft 4. The torque sensor and the column shaft 11 constitute a column assembly 31 formed as a single unit. The torque sensor 10 outputs a signal according to a torsion of the torsion bar 11a to the ECU 25. In this embodiment, the torque sensor 10 outputs a detection signal τd0 representing a steering torque as a digital signal.

Then, the ECU 25 calculates a motor torque command value, using a map, according to a steering torque detected by the torque sensor 10 and calculates a current command value based on the motor torque command value. Succeedingly the ECU 25 calculates a voltage command value through a current feedback control based on the current command value and calculates a motor control signal based on the voltage command value, thereby controlling supply of a driving power to the steering motor 21.

The steering device according to the embodiment is an electric power steering device of an independent torque sensor type in which the torque sensor 10 is provided independently from the MCU 20. A feature of this electric power steering device of an independent torque sensor type resides in a point that the torque sensor 10 is provided as close as possible to the steering wheel 2, which acts as a base of a steering operation inputted into the steering mechanism 1. Another feature resides in a point that the MCU 20 is disposed as close as possible to the steered wheels 3 to which the output of the steering mechanism 1 is applied. By doing so, a detection accuracy of the steering torque can be improved remarkably and also efficiency of the steering assist can be improved remarkably.

Still another feature of the embodiment resides in a point that the ECU 25 is incorporated into the MCU 20 as a single unit and the ECU 25 is installed outside a vehicle compartment. Thus, a wiring between the ECU 25 and the steering motor 21 can be made as short as possible and a transmission accuracy of a signal therebetween can be improved remarkably. Further, a loss of a transmission time etc. of the signal can also be reduced.

Next, configuration of the torque sensor 10 will be explained.

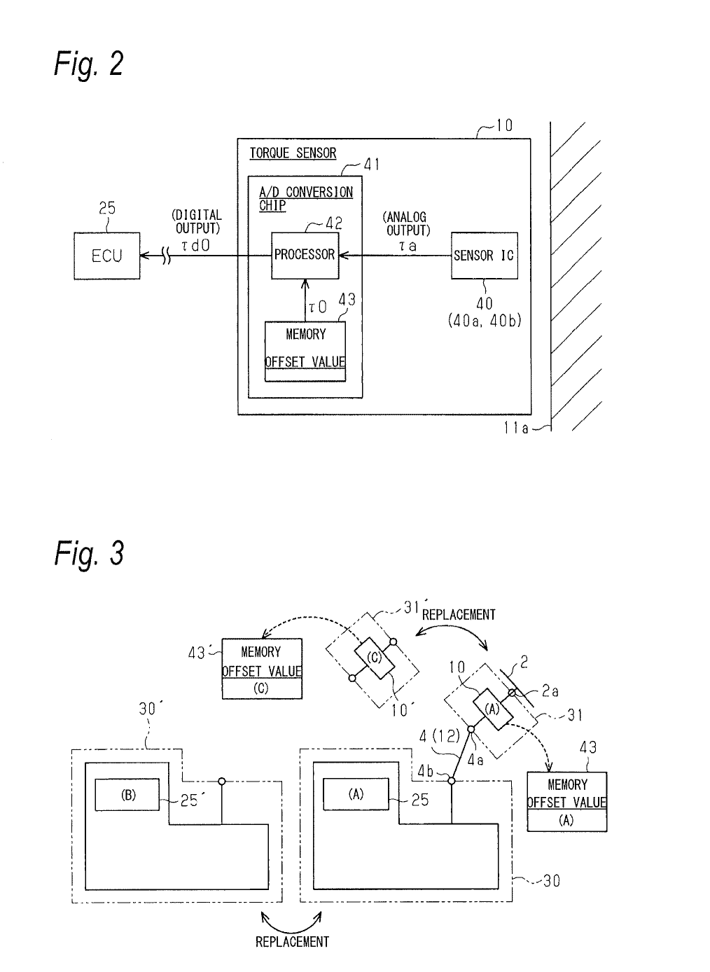

As shown in FIG. 2, the torque sensor 10 is disposed along the torsion bar 11a within the column shaft 11. The torque sensor 10 includes a sensor IC 40 acting as a detection unit for detecting a steering torque applied to the steering mechanism 1, that is, the steering shaft 4. The sensor IC 40 is a packaged Hall IC which is constituted of two Hall elements 40a, 40b and these elements are arranged along the circumferential direction of the torsion bar 11a.

The sensor IC 40 outputs a detection signal τa, as an analog signal, which is a voltage signal according to a magnetic flux detected by the Hall elements 40a, 40b. The detection signal τa includes voltage signals outputted from the Hall elements 40a, 40b.

The torque sensor 10 further includes an A/D conversion chip 41 acting as a conversion unit which performs a digital conversion of converting the detection signal τa outputted from the sensor IC 40 into a digital signal and outputs the digital signal. The A/D conversion chip 41 mounts a processor 42 for performing an arithmetic operation relating to the digital conversion and a memory 43 acting as a memory unit for storing unique information relating to the torque sensor 10. When the processor 42 of the A/D conversion chip 41 receives the detection signal τa, the processor converts the detection signal τa into a digital signal.

In general, each of the Hall elements 40a, 40b of the sensor IC 40 has an individual difference in a relation between a detected magnetic flux and a voltage signal outputted therefrom. Thus, in this embodiment, the A/D conversion chip 41 also performs an offset correction so as to match with a timing of the digital conversion. The offset correction is a function of correcting the output level of the sensor IC in a case where a magnetic flux detected by each of the Hall elements 40a, 40b is “0”. By the offset correction, a detection deviation of a neutral position of the steering wheel 2, that is, a value “0” of a detected steering torque is corrected. At the time of the digital conversion, the offset correction may be performed as to an analog signal before the digital conversion or as to a digital signal after the digital conversion.

To this end, the memory 43 mounted in the A/D conversion chip 41 stores, as the unique information relating to the torque sensor 10, an offset value which is necessary for the offset correction and used for providing offset for a value “0” of the detected steering torque. That is, the torque sensor 10 is provided with the memory 43 storing the offset value. As the offset value, a value according to an analog signal or a digital signal is set so as to match with a timing of the offset correction. An offset value is set for each torque sensor at an optional timing before or after assembling of the steering device.

Then, at the time of performing the digital conversion, the A/D conversion chip 41 reads the offset value from the memory 43 and outputs, as a digital signal, a detection signal τd0 superimposed (added) with the offset value τ0. In this manner, the detection signal τd0 to be outputted to the ECU 25 is a signal having been subjected to the offset correction in advance. In other words, this detection signal is a signal in which the detection deviation of the neutral position of the steering wheel 2 has been already corrected. Thus, when the ECU 25 inputs the detection signal τd0, the ECU can calculate a steering torque based on the detection signal τd0 without subjecting this detection signal to the offset correction.

According to the steering device as explained above, the following effects can be attained.

In this embodiment, the memory 43 is always treated together with the torque sensor 10 as a set and hence the torque sensor 10 is accompanied by the memory. That is, an offset value of the torque sensor 10 is managed by the torque sensor 10.

Thus, in this embodiment, this means is very effective in a case where the torque sensor 10, i.e., the column assembly 31 and the ECU 25, i.e., the gear assembly 30 are required to be replaced due to an abnormality of the steering device.

Explanation will be made as to a case where the torque sensor 10, i.e., the column assembly 31 is replaced due to an abnormality of the steering device, as shown in FIG. 3. Each of the torque sensor 10 and the ECU 25 constituting the steering device before the replacement is referred to as an A individual element. That is, before the replacement, the column assembly 31 having the torque sensor 10 as the A individual element and the gear assembly 30 having the ECU 25 as the A individual element constitute the steering device. In this case, the memory 43 mounted in the torque sensor 10 as the A individual element stores an offset value (A) set according to the torque sensor 10 as the A individual element.

Then, the column assembly 31 having the torque sensor 10 as the A individual element is replaced by a column assembly 31′ having a torque sensor 10′ as a C individual element. A memory 43′ mounted in the torque sensor 10′ as the C individual element stores an offset value (C) set according to the torque sensor 10′ as the C individual element.

In this case, of course, the torque sensor 10′ as the C individual element outputs a detection signal τd0 subjected to the offset correction using the offset value (C). That is, although the ECU 25 as the individual element A is originally combined with the torque sensor 10 as the A individual element, the detection signal τd0 to be inputted for a use of the control is a signal subjected to the offset correction irrespective of before or after the replacement. Thus, even if the torque sensor itself is replaced, the control can be performed normally.

In this manner, at a time of replacing the torque sensor 10, i.e., the column assembly 31 due to an abnormality of the steering device, the replacement of the torque sensor 10 is not required to be grasped on the ECU 25 side. That is, even if the torque sensor 10 is replaced, it is not necessary to perform any measure of mutually relating the ECU 25 and the torque sensor 10. Accordingly, even if the torque sensor is replaced, a suitable offset value can be reflected on a detection result of the torque sensor 10′.

Explanation will be made as to a case where the ECU 25, i.e., the gear assembly 30 is replaced due to an abnormality of the steering device, as shown in FIG. 3. Like the aforesaid case, each of the torque sensor 10 and the ECU 25 constituting the steering device before the replacement is referred to as an A individual element.

The gear assembly 30 having the ECU 25 as the A individual element is replaced by a gear assembly 30′ having an ECU 25′ as a B individual element. In this case, as the torque sensor 10 as the A individual element is not replaced, the memory 43 mounted in the torque sensor 10 as the A individual element stores the offset value (A) set according to the torque sensor 10 as the A individual element.

In this case, of course, the torque sensor 10 as the A individual element outputs a detection signal τd0 subjected to the offset correction using the offset value (A). That is, although the ECU 25′ as the B individual element differs from one originally combined with the torque sensor 10 as the A individual element, the detection signal τd0 to be inputted for a use of the control is a signal subjected to the offset correction irrespective of before or after the replacement. Thus, even if the ECU itself is replaced, the control can be performed normally.

In this manner, at the time of replacing the ECU 25, i.e., the gear assembly 30 due to an abnormality of the steering device, as the offset value of the torque sensor 10 is managed by the torque sensor 10, the ECU 25′ is not required to perform any particular setting as to the offset value of the torque sensor 10. Accordingly, even if the ECU 25 is replaced, a suitable offset value can be reflected on a detection result of the torque sensor 10.

As described above, in this embodiment, even if the ECU 25 and the torque sensor 10 are not mutually related, the control can be performed normally by the ECU 25. In this manner, as it is not necessary to perform any measure of mutually relating the ECU 25 and the torque sensor 10, the reflection of suitable offset value can also be performed effectively at an assembling process in a manufacturing factory of the steering devices.

That is, in the manufacturing factory, so long as setting of an offset value to the torque sensor 10 is completed, the steering device can be assembled by suitably combining constituent elements without caring the relation with the ECU 25. This is also same in a case of replacing the ECU 25 or the torque sensor 10. In this case, the steering device can be assembled suitably without caring the combination of the ECU and the torque sensor. Thus, efficiency of workability can be improved at a situation relating to the assembling of the steering device.

This embodiment employs a specification that the ECU 25 inputs a digital signal as the detection signal τd0. In a case where the torque sensor 10 outputs a digital signal to the ECU 25 in this manner, it is recommended to mount the memory 43 in the A/D conversion chip 41 and to reflect the offset value stored in the memory 43 at the time of the digital conversion of the A/D conversion chip 41.

As described above, as the memory 43 is mounted by the recommended combination, this combination contributes to easy securing of a space for mounting the memory and also to simplification of a configuration relating to the reflection of the offset value.

In this embodiment, usually, as a detection result of the torque sensor is subjected to the offset correction, the torque sensor 10 can individually manage the offset value having a high versatility. Thus, versatility of the torque sensor 10 mounting the memory 43 can be enhanced.

Next, the second embodiment of the steering device will be explained. This embodiment mainly differs from the first embodiment in a mounting method of the memory in the torque sensor. In this embodiment, configurations and control contents identical to those of the first embodiment are referred to by the common symbols etc., with explanation thereof being omitted.

In this embodiment, the torque sensor 10 outputs a detection signal τa0 representing a steering torque as an analog signal.

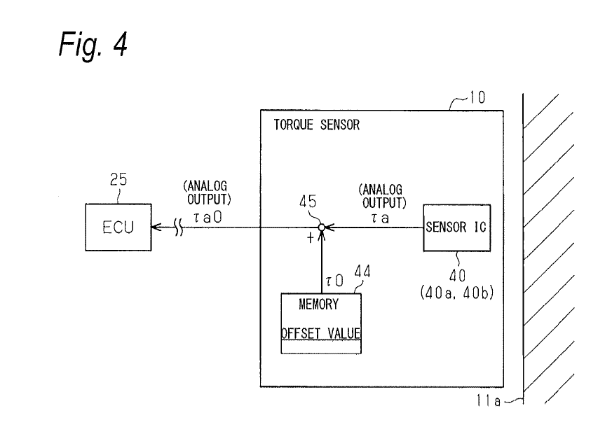

As shown in FIG. 4, the torque sensor 10 mounts a memory 44, serving as a memory unit storing unique information relating to the torque sensor 10, independently from the sensor IC 40. In this embodiment, the offset correction is performed so as to match with an output timing of an analog signal from the sensor IC 40. The memory 44 in this embodiment stores, as the unique information relating to the torque sensor 10, an offset value which is necessary for the offset correction and used for providing offset for a value “0” of the detected steering torque. A value according to the analog signal is set as the offset value.

More specifically, the torque sensor 10 according to this embodiment mounts an adder 45 for superimposing (adding) an offset value τ0 stored in the memory 44 on a detection signal τa from the sensor IC. The adder 45 superimposes the offset value τ0 on the detection signal τa outputted from the sensor IC 40 and outputs the detection signal τa0 as the analog signal. In this manner, the detection signal τa0 to be outputted to the ECU 25 is a signal subjected to the offset correction in advance, that is, a signal in which the detection deviation of the neutral position of the steering wheel 2 is already corrected. Thus, when the ECU 25 inputs the detection signal τa0, the ECU can calculate a steering torque based on the detection signal τa0 without subjecting this detection signal to the offset correction.

According to the steering device as explained above, in addition to the effects of the first embodiment, the following effects can be attained.

This embodiment employs a specification that the ECU 25 inputs an analog signal as the detection signal τd0. In a case where the torque sensor 10 outputs an analog signal to the ECU 25 in this manner, it is recommended to mount the memory 44 separately from the sensor IC 40 and further to reflect the offset value stored in the memory 44 on the analog signal outputted from the sensor IC.

As described above, as the memory 44 is mounted by the recommended combination, this combination contributes to easy securing of a space for mounting the memory and further to simplification of a configuration relating to the reflection of the offset value.

Each of the embodiments can also be implemented in the following modes by suitably modifying the each embodiment. That is, although the torque sensor 10 includes the memory 43 or 44 storing the offset value, the torque sensor may output a detection signal to the ECU 25 without performing the offset correction. In this case, the torque sensor 10 outputs the offset value stored in the memory 43 or 44 to the ECU 25. Then, the ECU 25 subjects the detection signal to the offset correction based on the offset value inputted from the torque sensor 10. Alternatively, an ECU for performing the offset correction may be provided separately from the torque sensor 10 and the ECU 25. In this case, the torque sensor 10 outputs the offset value stored in the memory 43 or 44 to the ECU for performing the offset correction.

The unique information stored in the memory 43 or 44 is not limited to the offset value but may be other information so long as it is a value for correcting the detection signal as a detection result. For example, the unique information may be a correction value for correcting linearity of the detection result. According to this modification, even in a case of correcting linearity of the detection result caused by an error of the torque sensor, that is, an error of each of the Hall sensors, the correction value according to the torque sensor constituting the steering device can be accurately reflected on the detection result. Further, the unique information is not limited to a single kind of correction value but may be a combination of plural kinds of correction values that are stored in the memory. In this case, the correction processing is not limited to a single kind of correction processing but may be a combination of plural kinds of correction processing.

The steering shaft 4 may be configured so as to be dividable at least into the column shaft 11 and another constituent element. For example, the column shaft 11 may be coupled to the pinion shaft 13. Further, the intermediate shaft 12 or the pinion shaft 13 may be configured to be dividable. The steering device is merely required to be dividable into two units, that is, the gear assembly 30 and the column assembly 31.

In the first embodiment, the memory 43 may be mounted separately from the A/D conversion chip 41. In this case, at the time of performing the offset correction, the processor 42 may obtain (input) the offset value from the memory 43. On the other hand, concerning the offset correction, an processor for performing the offset correction may be provided separately from the processor 42.

The ECU 25 of the second embodiment may mount an A/D conversion chip at an input port thereof so as to be able to input the detection result from the torque sensor 10 as a digital signal. Although each of the embodiments is explained as to an example applied to the torque sensor using the Hall elements, the torque sensor may be another type using resolvers or the like.

In each of the embodiments, a brushless motor may be employed as the steering motor 21. In this case, in order to control rotation of the motor, it is required to provide a rotation angle sensor which detects a rotation angle of the steering motor 21 and outputs the detection result to the ECU 25.

The steering device in each of the embodiments may be a so-called pinion-type electric power steering device in which power of the steering motor 21 is applied to the pinion shaft 13 (rack and pinion mechanism 5) of the gear assembly 30. Further, each of the embodiments can also be applied to a rack-parallel type or a rack-direct type electric power steering device as the rack-direct type electric power steering device.

Technical concept of the invention grasped from the respective embodiments and the other examples (modified examples) will be additionally described below.

The torque sensor outputs the detection result reflecting the unique information stored in the memory to the control unit. According to this configuration, the control unit can realize normal control so long as the control unit merely inputs the detection result from the torque sensor.

According to the aforesaid configuration, the memory unit is always treated together with the torque sensor as a set and hence the torque sensor is accompanied by the memory unit. That is, the unique information of the torque sensor is managed by the torque sensor. Thus, at a time of replacing the torque sensor, i.e., the column shaft due to an abnormality of the steering device, replacement of the torque sensor (column shaft) is not required to be grasped on the control unit side. In this manner, even if the torque sensor is replaced, it is not necessary to perform any measure of mutually relating the control unit and the torque sensor. Accordingly, even if the torque sensor is replaced, suitable unique information can be reflected on a detection result of the torque sensor

Further, according to the aforesaid configuration, at a time of replacing the control unit due to an abnormality of the steering device, as the unique information of the torque sensor is managed by the torque sensor, the control unit is not required to perform any particular setting as to the unique information of the torque sensor. Accordingly, even if the control unit is replaced, suitable unique information can be reflected on a detection result of the torque sensor

Further, as it is not necessary to perform any measure of mutually relating the control unit and the torque sensor, the reflection of suitable unique information can also be performed effectively at an assembling process in a manufacturing factory of the steering devices. That is, in the manufacturing factory, so long as setting of the unique information to the torque sensor is completed, the steering device can be assembled by suitably combining constituent elements without caring the relation between the control unit and the torque sensor. This is also same in a case of replacing the control unit or the torque sensor. In this case, the steering device can be assembled suitably without caring the combination of the control unit and the torque sensor after the replacement. Thus, efficiency of workability can be improved at a situation relating to the assembling of the steering device.

As described above, as the memory unit is mounted by the recommended combination, this combination contributes to easy securing of a space for mounting the memory unit and further to simplification of a configuration relating to the reflection of the unique information.

The unique information stored in the memory unit contains, for example, an offset value for subjecting a detection result of the torque sensor to an offset correction. Usually, as a detection result of the torque sensor is subjected to the offset correction, the torque sensor is configured to be able to individually manage the unique information having a high versatility. Thus, the torque sensor configured above can be enhanced in its versatility.

According to the invention, suitable unique information can be reflected on a detection result of the torque sensor even in a case of replacing the torque sensor.

What is claimed is:

1. A steering device, comprising:
a steering mechanism which includes a steering shaft coupled with a steering wheel and a steered shaft coupled with steered wheels;
a steering actuator which applies an assist torque to the steered shaft;
a torque sensor which detects a steering torque applied to the steering shaft; and
a control unit which controls the steering actuator so as to generate the assist torque based on the steering torque detected by the torque sensor, wherein
the steering shaft includes a column shaft which is dividable from another constituent element of the steering shaft,
the steering actuator and the control unit are provided as a single unit,
the torque sensor is provided at the column shaft, and
the torque sensor mounts therein a memory unit for storing unique information of the torque sensor.

2. The steering device according to claim 1, wherein
the torque sensor includes a detection unit which detects the steering torque and outputs the detected steering torque as an analog signal, and a conversion unit which converts the analog signal into a digital signal and outputs the digital signal to the control unit,
the memory unit is mounted in the conversion unit, and
the unique information stored in the memory unit is reflected when the conversion unit converts the analog signal to the digital signal.

3. The steering device according to claim 1, wherein
the torque sensor includes a detection unit which detects the steering torque and outputs the detected steering torque as an analog signal to the control unit,
the memory unit is mounted separately from the detection unit, and
the unique information stored in the memory unit is reflected on the analog signal output from the detection unit.

4. The steering device according to claim 1, wherein
the unique information contains an offset value for offsetting the steering torque detected in the torque sensor.
